(19) United States
(12) Patent Application Publication
(10) Pub. No.: US 2017/0230381 A1
(43) Pub. Date: Aug. 10, 2017

(54) METHOD FOR PROCESSING PROSE SERVICE AUTHORIZATION CHANGE, FIRST NETWORK ELEMENT AND SECOND NETWORK ELEMENT

(71) Applicant: ZTE CORPORATION, Shenzhen City (CN)

(72) Inventors: Shuang LIANG, Shenzhen City (CN); Jinguo ZHU, Shenzhen City (CN); Fei LU, Shenzhen City (CN)

(73) Assignee: ZTE CORPORATION, Shenzhen City (CN)

(21) Appl. No.: 15/321,166

(22) PCT Filed: Nov. 17, 2014
(86) PCT No.: PCT/CN2014/091296

§ 371 Date: Apr. 17, 2017

(30) Foreign Application Priority Data
Jun. 24, 2014 (CN) 201410288665.7

(51) Int. Cl. H04L 29/06; H04W 60/04; H04W 12/08; H04W 8/04

(52) U.S. Cl. CPC H04L 63/107; H04W 8/04; H04W 60/04; H04W 12/08; H04L 63/108; H04W 88/02

(57) ABSTRACT

A method for processing an authorization change of a Proximity-based Service (ProSe), a first network element device, and a second network element device are described. The method includes that: a ProSe server of a visited network or a local network triggers reauthorization of the ProSe; and the ProSe server of the visited network or the local network sends updated authorization information to a ProSe server of a home network. The updated authorization information includes: an update time limitation indication, and/or time information, and/or an authorization type.

### CROSS-REFERENCE TO RELATED APPLICATION

This application is the U.S. national phase of PCT Application No. PCT/CN2014/091296 filed Nov. 17, 2014, which claims priority to Chinese Application No. 201410288665.7 filed Jun. 24, 2014, the disclosures of which are incorporated in their entirety by reference herein.

### TECHNICAL FIELD

The present document relates to the field of mobile communication, and more particularly to a method for processing an authorization change of a Proximity-based Service (ProSe), a first network element device, a second network element device and a third network element device.

### BACKGROUND OF THE RELATED ART

In a process of implementing the technical solutions of the embodiment of the present document, the inventor of the present document at least finds the following technical problems in a related technology:

in order to keep competitive power of a 3rd-Generation (3G) mobile communication system in the field of communication, provide higher-rate, lower-delay and more personalized mobile communication service for a user and simultaneously reduce operation cost of an operating company, a 3rd Generation Partnership Project (3GPP) standard working group is committed to researches on an Evolved Packet System (EPS).

When two pieces of User Equipment (UE) communicate through an EPS network, the two pieces of UE are required to create bearers through an EPS respectively. However, in consideration of rapid development of intelligent UE and various mobile Internet services, it is expected to find proximal friends for communication in many services, so that ProSes are promoted to emerge. UE supporting such a function may communicate through a specific resource authorized by a network. At this moment, a communication path may not lead back to a core network. Such a communication manner reduces detouring of a data route on one hand, and also reduces a network data load on the other hand.

After introduction of a ProSe, some network elements and interfaces are added in a network to support this function, specifically as shown in FIG. 1 (a system architecture diagram of FIG. 1 only includes network elements related to the present document):

UEA/UEB supporting a ProSe function: which may discover and communicate with each other after obtaining an authorization from a network side;

a ProSe function: the function entity is arranged to support introduction of a ProSe, and mainly finishes authorization about that the UE discovers and is discovered and matching, and in some solutions, the network element is also responsible for mutual discovery of the protocol UE;

an Evolved Universal Terrestrial Radio Access Network (EUTRAN): which provides bottom-layer access and necessary discovery and communication resources for a ProSe UE;

an Evolved Packet Core Network (EPC): which includes a Mobility Management Entity (MME) and a Serving Gateway/Packet Data Network Gateway (SGW/PGW), herein these network elements provides bottom-layer access for the UE to access the ProSe function;

a Home Subscriber Server (HSS): which includes all functions of a Home Location Register (HLR), is a permanent storage location of subscription data of a user and is located in a subscribed home network of the user, herein the network element is required to store subscription data related to the ProSe after the ProSe is introduced;

a Secure User Plane Location Platform (SLP): which is arranged to help to discover a proximal UE; and

a ProSe application server: which is arranged to map an identifier of a user application layer and a user identifier of the user in a 3GPP network.

When being expected to be identified by another UE in a network, a ProSe UE is required to initiate an authorization request to its own ProSe function, and once being successfully authorized, the UE may broadcast its own identity in the network for another user to discover. While for a UE which expects to discover another UE, the UE may monitor a specific channel or content to discover a specific user after network authorization is finished.

When UE requests to use a ProSe, i.e. device-to-device discovery and communication, a subscription authorization and an authorization of a ProSe function entity are required. If being in a roaming state, the UE also requires an authorization of a visited network. These authorizations may also be withdrawn in a specific environment, and once the authorizations are withdrawn, the UE is forbidden to use the ProSe. An authorization withdrawing flow of a Visited Public Land Mobile Network (VPLMN) is shown in FIG. 2.

In Step 201, a visited network or a local network triggers reauthorization of a ProSe due to an authorization change of the ProSe. The visited network or the local network initiates a service policy change notice to a home network of UE. The notice may be initiated for a specific UE, may also be initiated for all UEs in a Public Land Mobile Network (PLMN), the former is required to carry International Mobile Subscriber Identification Number (IMSI) information, and the latter is required to indicate a PLMN of which UE is required to be reauthorized, i.e. a Home Public Land Mobile Network Identifier (HPLMN ID) of the home network of the UE. The notice further carries an ID of a PLMN receiving a policy change, i.e. the PLMN initiating reauthorization, and service policy changes, for example, a communication and/or discovery process requires reauthorization.

In Step 202, a ProSe server of the home network initiates a service change notice to an affected UE after receiving the service policy change notice, or notifies the UE of a service change when the UE initiates a service request next time. If the IMSI is not carried in Step 201, the ProSe server may be required to send multiple messages to the related UE.

In Steps 203˜204, the ProSe server of the home network sends updated service policy data carrying changed ProSe service data to a Home Subscriber Server (HSS). If the IMSI is included in Step 201, the IMSI is required to be included in Step 203. If the notice does not carry the IMSI, the HSS is required to judge which UEs may be affected according to the ID of the PLMN which requires reauthorization, and updates subscription data of the UE.

Here, the HSS is abbreviation of Home Subscriber Server, and is an important part of a control layer in an Internet Protocol (IP) Multimedia Subsystem (IMS). The HSS supports a main user database of an IMS network entity arranged to process calling/sessions, includes a user configuration file, executes identity authentication and authorization of a user, and may provide information about a physical location of the user.

In Steps 205˜206, for the affected UE, the HSS may judge to reinsert user data into an MME where the UE is registered according to a registration state of the UE. The MME judges a policy change type, and if a broadcast policy of the UE changes and an S1 bearer is created for the UE, the MME is required to notify that authorization information of the ProSe changes through a user context modification message.

Thus it can be seen that, in the conventional technology, it is always necessary to notify to wirelessly withdraw a related resource through an HSS when authorizations of a visited network change because broadcast UE needs to use a network resource of the visited network. However, under some conditions, the authorizations may temporally change, for example, the authorizations temporally change due to traffic control, and the authorizations may be recovered after a period of time. Then, the HSS is required to process a lot of authorization change messages, and a load of the HSS is increased. Therefore, there is an urgent need in a solution for processing a temporary authorization change of a ProSe, to avoid impact of the authorization change of the ProSe on a network element such as the HSS and reduce a processing load of the network element such as the HSS.

### SUMMARY

In view of this, the embodiment of the present document is intended to provide a method for processing an authorization change of a ProSe, a first network element device, a second network element device and a third network element device, so as to at least solve the problem that a load of a network element such as an HSS is increased by impact of the authorization change of the ProSe on the network element such as the HSS.

The technical solutions of the embodiment of the present document are implemented as follows.

The embodiment of the present document provides a method for processing an authorization change of a ProSe, which includes that:

a ProSe server of a visited network or a local network triggers reauthorization of the ProSe; and

the ProSe server of the visited network or the local network sends updated authorization information to a ProSe server of a home network, the updated authorization information includes: an update time limitation indication, and/or time information, and/or an authorization type.

In the solution, the update time limitation indication is arranged to indicate that an authorization update type of the home network is a temporary update or a permanent update.

In the solution, after the ProSe server of the home network receives the updated authorization information, the method further includes that:

the ProSe server of the home network notifies UE of the updated authorization information; or,

the ProSe server of the home network sends an updated authorization notice to the UE to trigger the UE to initiate a service authorization request; or,

the ProSe server of the home network notifies the UE of the updated authorization information after the UE initiates the service authorization request.

In the solution, the method further includes that:

the ProSe server of the visited network or the local network receives the service authorization request initiated by the UE, and forwards the service authorization request to the ProSe server of the home network;

the ProSe server of the visited network or the local network receives a service authorization response for the service authorization request from the ProSe server of the home network, and acquires the updated authorization information carried in the service authorization response; and

the ProSe server of the visited network or the local network notifies the UE of the updated authorization information.

In the solution, the method further includes that:

the ProSe server of the home network receives the service authorization request initiated by the UE, and notifies the UE of the updated authorization information.

In the solution, the method further includes that:

the ProSe server of the home network receives the service authorization request initiated by the UE, and sends the service authorization request to the ProSe server of the visited network or the local network; and

the ProSe server of the visited network or the local network receives the service authorization request sent by the ProSe server of the home network, and returns a service authorization response for the service authorization request to the ProSe server of the home network, the updated authorization information is carried in the service authorization response.

In the solution, the method further includes that: the time information is set to be time information for temporary forbidding if the authorization update type is a temporary update; and

the time information includes: absolute time or relative time.

In the solution, an implementation manner for the update time limitation indication includes any one of manners as follows:

the update time limitation indication is implemented in a manner of adding a new Information Element (IE); and

the update time limitation indication is implemented in an implicit manner.

In the solution, implementation of the update time limitation indication in the implicit manner includes that:

if the time information is not carried, it is indicated that the update time limitation indication is arranged to indicate that the authorization update type of the home network is a permanent update; and

if the time information is carried, it is indicated that the update time limitation indication is arranged to indicate that the authorization update type of the home network is a temporary update and identify that the update is valid within a time period represented by the time information.

In the solution, the authorization type may include, but is not limited to: any one type of a full authorization, a conditional authorization and no authorization.

The embodiment of the present document provides a method for processing an authorization change of a ProSe, which includes that:

a ProSe server of a home network receives updated authorization information sent by a ProSe server of a visited network or a local network, the updated authorization information includes: an update time limitation indication, and/or time information, and/or an authorization type.

In the solution, the update time limitation indication is arranged to indicate that an authorization update type of the home network is a temporary update or a permanent update.

In the solution, the method further includes that:

the ProSe server of the home network notifies UE of the updated authorization information; or,

the ProSe server of the home network sends an updated authorization notice to the UE to trigger the UE to initiate a service authorization request; or,

the ProSe server of the home network notifies the UE of the updated authorization information after the UE initiates the service authorization request.

In the solution, the method further includes that:

the ProSe server of the home network receives a service authorization request sent by the ProSe server of the visited network or the local network, and returns a service authorization response for the service authorization request to the ProSe server of the visited network or the local network, the updated authorization information is carried in the service authorization response.

In the solution, the method further includes that:

the ProSe server of the home network receives the service authorization request initiated by the UE, and notifies the UE of the updated authorization information.

In the solution, the method further includes that:

the ProSe server of the home network receives the service authorization request initiated by the UE, and forwards the service authorization request to the ProSe server of the visited network or the local network; and

the ProSe server of the home network receives a service authorization response for the service authorization request returned by the ProSe server of the visited network or the local network, the updated authorization information is carried in the service authorization response.

In the solution, the method further includes that:

the ProSe server of the home network judges whether it is necessary to notify an HSS according to locally configured policy information.

In the solution, the method further includes that: the time information is time information for temporary forbidding if the authorization update type is a temporary update; and

the time information includes: absolute time or relative time.

In the solution, an implementation manner for the update time limitation indication includes any one of manners as follows:

the update time limitation indication is implemented in a manner of adding a new IE; and

the update time limitation indication is implemented in an implicit manner.

In the solution, implementation of the update time limitation indication in the implicit manner includes that:

if the time information is not carried, it is indicated that the update time limitation indication is arranged to indicate that the authorization update type of the home network is a permanent update; and

if the time information is carried, it is indicated that the update time limitation indication is arranged to indicate that the authorization update type of the home network is a temporary update and identify that the update is valid within a time period represented by the time information.

In the solution, the authorization type includes: any one type of a full authorization, a conditional authorization and no authorization.

The embodiment of the present document provides a first network element device, which includes:

a triggering unit, arranged for a ProSe server of a visited network or a local network to trigger reauthorization of a ProSe; and

a sending unit, arranged for the ProSe server of the visited network or the local network to send updated authorization information to a ProSe server of a home network, herein the updated authorization information includes: an update time limitation indication, and/or time information, and/or an authorization type.

In the solution, the update time limitation indication is arranged to indicate that an authorization update type of the home network is a temporary update or a permanent update.

In the solution, the first network element device further includes:

an update notification unit, arranged for the ProSe server of the home network to notify UE of the updated authorization information; or, for the ProSe server of the home network to send an updated authorization notice to the UE to trigger the UE to initiate a service authorization request; or, for the ProSe server of the home network to notify the UE of the updated authorization information after the UE initiates the service authorization request.

In the solution, the sending unit is further arranged for the ProSe server of the visited network or the local network to receive the service authorization request initiated by the UE, and forward the service authorization request to the ProSe server of the home network; for the ProSe server of the visited network or the local network to receive a service authorization response for the service authorization request from the ProSe server of the home network, and acquire the updated authorization information carried in the service authorization response; and for the ProSe server of the visited network or the local network to notify the UE of the updated authorization information.

In the solution, the first network element device further includes:

a notification unit, arranged for the ProSe server of the home network to receive the service authorization request initiated by the UE, and notify the UE of the updated authorization information.

In the solution, the sending unit may further be arranged to send the service authorization request to the ProSe server of the visited network or the local network; and

a receiving unit is arranged for the ProSe server of the visited network or the local network to receive the service authorization request sent by the ProSe server of the home network, and return a service authorization response for the service authorization request to the ProSe server of the home network, the updated authorization information is carried in the service authorization response.

In the solution, the time information may be set to be time information for temporary forbidding if the authorization update type is a temporary update; and

the time information includes: absolute time or relative time.

In the solution, an implementation manner for the update time limitation indication includes any one of manners as follows:

the update time limitation indication is implemented in a manner of adding a new IE; and

the update time limitation indication is implemented in an implicit manner.

In the solution, implementation of the update time limitation indication in the implicit manner includes that:

if the time information is not carried, it is indicated that the update time limitation indication is arranged to indicate that the authorization update type of the home network is a permanent update; and

if the time information is carried, it is indicated that the update time limitation indication is arranged to indicate that the authorization update type of the home network is a temporary update and identify that the update is valid within a time period represented by the time information.

In the solution, the authorization type includes: any one type of a full authorization, a conditional authorization and no authorization.

When executing processing, the triggering unit, the sending unit, the update notification unit, the notification unit and the receiving unit may be implemented by adopting a Central Processing Unit (CPU), a Digital Signal Processor (DSP) or a Field-Programmable Gate Array (FPGA).

The embodiment of the present document provides a second network element device, which includes:

a receiving unit, arranged for a ProSe server of a home network to receive updated authorization information sent by a ProSe server of a visited network or a local network, herein the updated authorization information includes: an update time limitation indication, and/or time information, and/or an authorization type.

In the solution, the update time limitation indication is arranged to indicate that an authorization update type of the home network is a temporary update or a permanent update.

In the solution, a notification unit is arranged for the ProSe server of the home network to notify UE of the updated authorization information; or, for the ProSe server of the home network to send an updated authorization notice to the UE to trigger the UE to initiate a service authorization request; or, for the ProSe server of the home network to notify the UE of the updated authorization information after the UE initiates the service authorization request.

In the solution, the receiving unit is further arranged for the ProSe server of the home network to receive a service authorization request sent by the ProSe server of the visited network or the local network, and return a service authorization response for the service authorization request to the ProSe server of the visited network or the local network, the updated authorization information is carried in the service authorization response.

In the solution, the receiving unit is further arranged for the ProSe server of the home network to receive the service authorization request initiated by the UE, and notify the UE of the updated authorization information.

In the solution, the receiving unit is further arranged for the ProSe server of the home network to, after forwarding the service authorization request to the ProSe server of the visited network or the local network, receive a service authorization response for the service authorization request returned by the ProSe server of the visited network or the local network, the updated authorization information is carried in the service authorization response.

In the solution, the second network element device further includes:

a judgment unit, arranged for the ProSe server of the home network to judge whether it is necessary to notify an HSS according to locally configured policy information.

In the solution, the time information is time information for temporary forbidding if the authorization update type is a temporary update; and

the time information includes: absolute time or relative time.

In the solution, an implementation manner for the update time limitation indication includes any one of manners as follows:

the update time limitation indication is implemented in a manner of adding a new IE; and

the update time limitation indication is implemented in an implicit manner.

In the solution, implementation of the update time limitation indication in the implicit manner includes that:

if the time information is not carried, it is indicated that the update time limitation indication is arranged to indicate that the authorization update type of the home network is a permanent update; and

if the time information is carried, it is indicated that the update time limitation indication is arranged to indicate that the authorization update type of the home network is a temporary update and identify that the update is valid within a time period represented by the time information.

In the solution, the authorization type includes: any one type of a full authorization, a conditional authorization and no authorization.

When executing processing, the receiving unit, the notification unit and the judgment unit may be implemented by adopting a CPU, a DSP or an FPGA.

The embodiment of the present document provides a method for processing an authorization change of a ProSe, which includes that:

a ProSe server of a home network is triggered to request an HSS for acquiring subscription data when UE initiates a service authorization request or a service request; and

the ProSe server of the home network acquires the subscription data, the subscription data includes time limitation information of an authorization.

In the solution, the method further includes that:

an MME is triggered to acquire the subscription data from the HSS in an attachment or location updating process by the UE,

the subscription data returned by the HSS includes the time limitation information of the authorization.

In the solution, the time limitation information of the authorization includes absolute time or relative time.

In the solution, when the time limitation information of the authorization in the subscription data changes, the HSS notifies the ProSe server of the home network or the MME of updated subscription data.

In the solution, when the time limitation information of the authorization is timed out, the ProSe server of the home network notifies the UE that the authorization has expired; or,

when the time limitation information of the authorization changes, the ProSe server of the home network may notify the UE of updated authorization information, or trigger the UE to initiate a service authorization request, or notify the UE of the updated authorization information after the UE initiates the service authorization request.

In the solution, when the time limitation information of the authorization is timed out, the MME notifies that authorization information of a wireless network element terminal changes.

The embodiment of the present document provides a third network element device, which includes:

a triggering unit, arranged to trigger a ProSe server of a home network to request an HSS for acquiring subscription data when UE initiates a service authorization request or a service request; and

an acquisition unit, arranged for the ProSe server of the home network to acquire the subscription data, wherein the subscription data includes time limitation information of an authorization.

In the solution, the triggering unit is further arranged for the UE to trigger an MME to acquire the subscription data from the HSS in an attachment or location updating process; and

the acquisition unit is further arranged to include the time limitation information of the authorization in the subscription data returned by the HSS.

In the solution, the time limitation information of the authorization includes absolute time or relative time.

In the solution, the network element device further includes:

a first notification unit, arranged for the HSS to, when the time limitation information of the authorization in the subscription data changes, notify the ProSe server of the home network or the MME of updated subscription data.

In the solution, the network element device further includes:

a second notification unit, arranged for the ProSe server of the home network to, when the time limitation information of the authorization is timed out, notify the UE that the authorization has expired; or,

for the ProSe server of the home network to, when the time limitation information of the authorization changes, notify the UE of updated authorization information, or trigger the UE to initiate a service authorization request, or notify the UE of the updated authorization information after the UE initiates the service authorization request.

In the solution, the network element device further includes:

a third notification unit, arranged for the MME to, when the time limitation information of the authorization is timed out, notify that authorization information of a wireless network element changes.

When executing processing, the triggering unit, the acquisition unit, the first notification unit, the second notification unit and the third notification unit may be implemented by adopting a CPU, a DSP or an FPGA.

According to the method for processing the authorization change of the ProSe in the embodiment of the present document, the method includes that: the ProSe server of the visited network or the local network triggers reauthorization of the ProSe; and the ProSe server of the visited network or the local network sends the updated authorization information to the ProSe server of the home network, the updated authorization information includes the update time limitation indication, and/or the time information, and/or the authorization type. By the embodiment of the present document, processing is implemented without the HSS, so that the problem that a load of a network element such as the HSS is increased by impact of the authorization change of the ProSe on the network element such as the HSS is solved.

### BRIEF DESCRIPTION OF DRAWINGS

FIG. 1 is a structure diagram of main network elements of a system with a ProSe function being introduced according to a conventional art;

FIG. 2 is a flowchart of notification of an authorization change of a ProSe according to the conventional art;

FIG. 3 is a principle flowchart of implementation of an authorization change of a ProSe according to an embodiment of the present document;

FIG. 4 is a structure diagram of a first network element device according to an embodiment of the present document;

FIG. 5 is a schematic diagram of a first notification flow of an authorization change of a ProSe according to an embodiment of the present document;

FIG. 6 is a schematic diagram of a second notification flow of an authorization change of a ProSe according to an embodiment of the present document; and

FIG. 7 is a schematic diagram of addition of time limitation information of an authorization into subscription data of a ProSe according to an embodiment of the present document.

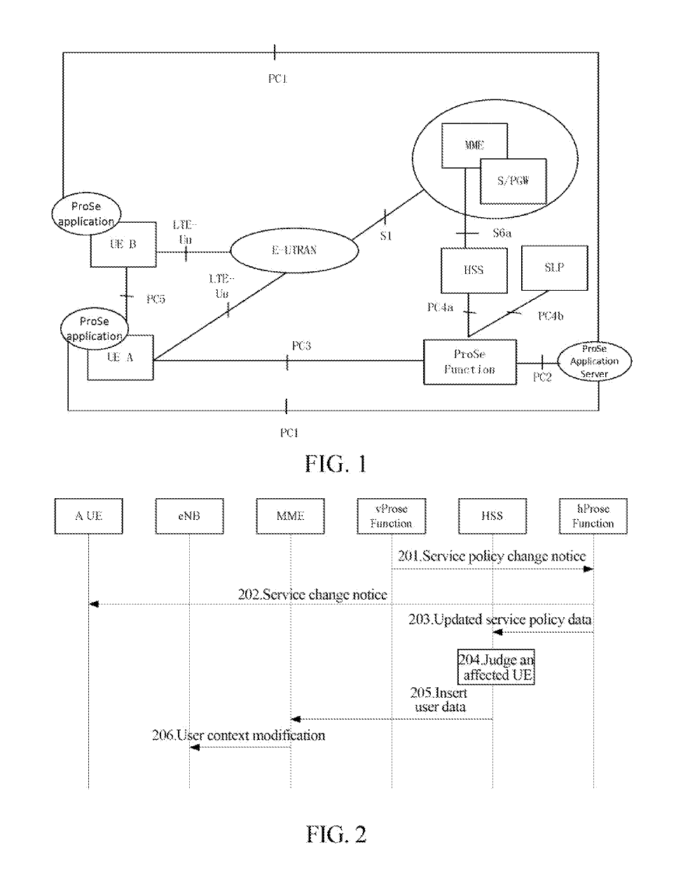

### SPECIFIC EMBODIMENTS

Implementation of the technical solutions will be further described below with reference to the drawings in detail.

In order to make a purpose, technical solutions and advantages of the present document clearer, the present document will be further described below with reference to the drawings in detail.

The present document provides a solution for processing a temporary authorization change of a ProSe, which may solve the problem that a load of a network element such as an HSS is increased by impact of the authorization change of the ProSe on the network element such as the HSS and reduce the processing load of the network element such as the HSS.

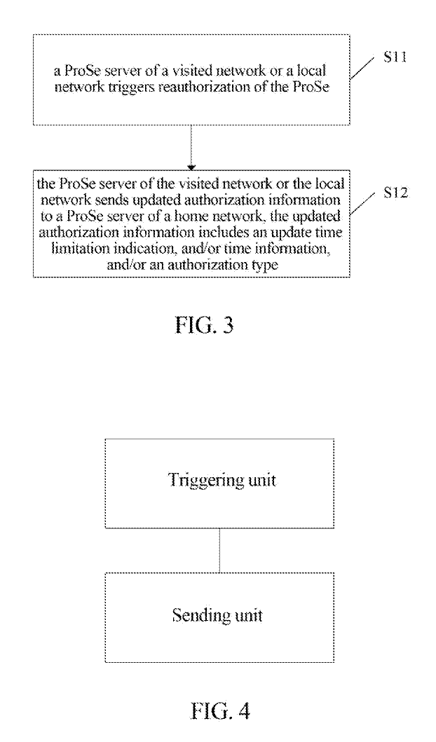

A method for processing an authorization change of a ProSe, as shown in FIG. 3, includes the following steps.

In Step S11, a ProSe server of a visited network or a local network triggers reauthorization of the ProSe.

In Step S12, the ProSe server of the visited network or the local network sends updated authorization information to a ProSe server of a home network, the updated authorization information includes an update time limitation indication, and/or time information, and/or an authorization type.

By Step S11 to Step S12, the ProSe server of the home network may notify the UE of the updated authorization information, or send an updated authorization notice to UE to trigger the UE to initiate a service authorization request; or, the ProSe server of the home network sends the updated authorization notice to the UE to notify the UE of the updated authorization information after the UE initiates the service authorization request.

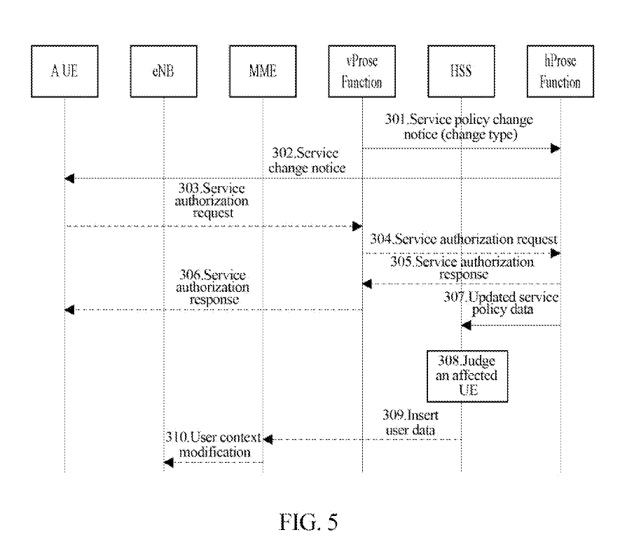

A first network element device, as shown in FIG. 4, includes:

a triggering unit, arranged for a ProSe server of a visited network or a local network to trigger reauthorization of the ProSe; and

a sending unit, arranged for the ProSe server of the visited network or the local network to send updated authorization information to a ProSe server of a home network, herein the updated authorization information includes an update time limitation indication, and/or time information, and/or an authorization type.

A method for processing an authorization change of a ProSe includes:

Step S21, a ProSe server of a home network receives updated authorization information sent by a ProSe server of a visited network or a local network, the updated authorization information includes an update time limitation indication, and/or time information, and/or an authorization type.

After Step S21, the method further includes:

Step S21, the ProSe server of the home network notifies UE of the updated authorization information; or, the ProSe server of the home network sends an updated authorization notice to the UE to trigger the UE to initiate a service authorization request; or, the ProSe server of the home network notifies the UE of the updated authorization information after the UE initiates the service authorization request.

A second network element device includes:

a receiving unit, arranged for a ProSe server of a home network to receive updated authorization information sent by a ProSe server of a visited network or a local network, herein the updated authorization information includes an update time limitation indication, and/or time information, and/or an authorization type.

The second network element device further includes:

a notification unit, arranged for the ProSe server of the home network to notify UE of the updated authorization information; or, for the ProSe server of the home network to send an updated authorization notice to the UE to trigger the UE to initiate a service authorization request; or, for the ProSe server of the home network to notify the UE of the updated authorization information after the UE initiates the service authorization request.

A method for processing an authorization change of a ProSe includes the following steps.

In Step S31, a ProSe server of a home network is triggered to request an HSS for acquiring subscription data when UE initiates a service authorization request or a service request.

In Step S32, the ProSe server of the home network acquires the subscription data, the subscription data includes time limitation information of an authorization.

A third network element device includes:

a triggering unit, arranged to trigger a ProSe server of a home network to request an HSS for acquiring subscription data when UE initiates a service authorization request or a service request; and

an acquisition unit, arranged for the ProSe server of the home network to acquire the subscription data, the subscription data including time limitation information of an authorization.

The present document will be elaborated below with embodiments of specific application scenarios.

### Embodiment 1

An example of a notification flow of a temporary authorization change of a ProSe, as shown in FIG. 5, includes the following steps.

In Step 301, due to an authorization change of a ProSe, a visited network or a local network triggers reauthorization of the ProSe, and the visited network or the local network initiates a service policy change notice to a home network of UE, herein the authorization change may be temporary.

Here, the service policy change notice message may be initiated for a specific UE, may also be initiated for all UEs in a PLMN, the former is required to carry IMSI information of the UE, and the latter is required to indicate a PLMN of which UE is required to be reauthorized, i.e. a HPLMN ID of the home network of the UE.

Here, the service policy change notice message further carries an ID of a PLMN receiving a policy change, i.e. the PLMN initiating reauthorization, and service policy changes, for example, a communication and/or discovery process requires reauthorization.

Here, the service policy change notice message may further carry an authorization update type, and an update time limitation indication specifically indicates the home network authorization update type, i.e. whether the authorization change is a permanent update or a temporary update.

In case of a temporary update, time information for temporary forbidding may further be provided. The time information may be absolute time, and may also be relative time.

The above update time limitation indication may be implemented by adding a new IE, or may be implemented in an implicit manner. For example, if the time information is not carried, it is a permanent update, and if the time information is carried, it is identified that the update is valid within a time period represented by the time information.

The service policy change notice message may further carry an authorization type, for example, any one of a full authorization, a conditional authorization and no authorization.

In Step 302, after receiving the service policy change notice, a ProSe server of the home network initiates a notice to the affected UE or notifies the UE of the service change when the UE initiates a service authorization request next time.

Here, if the IMSI is not carried in Step 301, the ProSe server may be required to send multiple messages to the related UE. Here, a manner for notifying the UE may be directly notifying the UE of a specific content of the updated authorization change, or only notifying the UE of authorization updating to trigger the UE to reinitiate an authorization request process to obtain the specific updated content, that is, Steps 303˜306 are executed.

Here, if the authorization update type and/or the time information and/or the authorization type are carried in Step 301, the ProSe server of the home network may notify the UE of the above information.

Or, the above information is not sent, and the UE is only notified that it is necessary to initiate reauthorization of the ProSe and acquire updated authorization information in subsequent Steps 303˜306. In order to reduce message interaction, a direct notification manner (that is, Steps 303˜306 are not executed) is recommended under a condition that access is forbidden. For a conditional authorization, a manner of notifying the UE to reacquire the authorization information (that is, Steps 303˜306 are executed) may be selected.

In Steps 303˜306, after receiving a reauthorization notice, the UE reinitiates a service authorization request to a ProSe server of the visited network, and the ProSe server of the visited network or the local network sends the authorization request to the ProSe server of the home network. The ProSe server of the home network returns an authorization request response carrying updated authorization information of the UE to the ProSe server of the visited network or the local network. The ProSe server of the visited network or the local network returns a final service authorization response carrying the updated authorization update type and/or time information and/or authorization type in Step 301 to the UE according to a local policy.

In Steps 307˜308, the ProSe server of the home network sends updated service policy data carrying changed ProSe service data to an HSS. Here, if the IMSI is carried in Step 301, the IMSI is required to be carried in Step 307. If the IMSI is not carried, the ProSe server of the home network may check the affected UE and send multiple messages to the HSS for the affected UE. Or the ProSe server of the home network sends only one message carrying the changed PLMN identification, and the HSS checks the affected UE in Step 309.

Here, if the authorization update type and the time information are carried in Step 301, the ProSe of the home network may judge whether it is necessary to notify the HSS according to locally configured policy information. For example, temporary authorization withdrawing may not be notified to the HSS, or the authorization update type and the time information are carried in the message for notifying the HSS in Step 307. The message may further carry the authorization type, for example, one of a full authorization, a conditional authorization and no authorization.

If the message does not carry the IMSI, the HSS is required to judge the UE which may be affected according to the ID of the PLMN requiring reauthorization, and update its subscription data.

In Steps 309˜310, for the affected UE, the HSS may judge to reinsert user data into a MME where the UE is registered according to a registration state of the UE. The MME judges a policy change type, and if a broadcast policy of the UE changes and an 51 bearer is created for the UE, the MME is required to notify that authorization information of the ProSe changes through a user context modification message.

If the authorization update type and the time information are carried in Step 307, the authorization update type and the time information may also be included in the subscription data inserted by the HSS.

### Embodiment 2

An example of a second notification flow of an authorization change of a ProSe, as shown in FIG. 6, includes the following steps.

In Step 401, due to an authorization change of a ProSe, a visited network or a local network triggers reauthorization of the ProSe, and the visited network or the local network initiates a service policy change notice to a home network of UE, herein the authorization change may be temporary.

Here, the service policy change notice message may be initiated for a specific UE, may also be initiated for all UEs in a PLMN, the former is required to carry IMSI information of the UE, and the latter is required to indicate a PLMN of which UE is required to be reauthorized, i.e. a HPLMN ID of the home network of the UE.

Here, the service policy change notice further carries an ID of a PLMN receiving a policy change, i.e. the PLMN initiating reauthorization, and service policy changes, for example, a communication and/or discovery process requires reauthorization.

Here, the service policy change notice message may further carry an authorization update type, and an update time limitation indication specifically indicates the home network authorization update type, i.e. whether the authorization change is a permanent update or a temporary update.

In case of a temporary update, time information for temporary forbidding may further be provided. The time information may be absolute time, and may also be relative time.

The above update time limitation indication may be implemented by adding a new IE, or may be implemented in an implicit manner. For example, if the time information is not carried, it is a permanent update, and if the time information is carried, it is identified that the update is valid within a time period represented by the time information.

The service policy change notice message may further carry an authorization type, for example, any one of a full authorization, a conditional authorization and no authorization.

In Step 402, after receiving the service policy change notice, a ProSe server of the home network initiates a notice to the affected UE or notifies the UE of the service change when the UE initiates a service authorization request next time.

Here, if the IMSI is not carried in Step 401, the ProSe server may be required to send multiple messages to the related UE.

Here, a manner for notifying the UE may be directly notifying the UE of a specific content of the updated authorization change, or only notifying the UE of authorization updating to trigger the UE to reinitiate an authorization request process to obtain the specific updated content, that is, Steps 403˜406 are executed.

Here, if the authorization update type and/or the time information and/or the authorization type are carried in Step 401, the ProSe server of the home network may notify the UE of the above information.

Or, the above information is not sent, and the UE is only notified that it is necessary to initiate reauthorization of the ProSe and acquire updated authorization information in subsequent Steps 403˜406. In order to reduce message interaction, a direct notification manner (that is, Steps 403˜406 are not executed) is recommended under a condition that access is forbidden. For a conditional authorization, a manner of notifying the UE to reacquire the authorization information (that is, Steps 403˜406 are executed) may be selected.

In Steps 403˜406, after receiving a reauthorization notice, the UE reinitiates a service authorization request to the ProSe server of the home network. Optionally, the ProSe server of the home network sends the authorization request to the ProSe server of the visited network or the local network, and the ProSe server of the visited network or the local network returns an authorization request response carrying updated authorization information of the UE to the

ProSe server of the home network. Since the home network has acquired the latest information in Step 401, so that Steps 404˜405 are optional. The ProSe server of the home network returns a final service authorization response carrying the updated authorization update type and/or time information and/or authorization type in Step 401 to the UE according to a local policy.

In Steps 407˜408, the ProSe server of the home network sends updated service policy data carrying changed ProSe service data to an HSS.

Here, if the IMSI is carried in Step 401, the IMSI is required to be carried in Step 407. If the IMSI is not carried, the ProSe server of the home network may check the affected UE and send multiple messages to the HSS for the affected UE. Or the ProSe server of the home network sends only one message carrying the changed PLMN identification, and the HSS checks the affected UE in Step 409.

Here, if the authorization update type and the time information are carried in Step 401, the ProSe of the home network may judge whether it is necessary to notify the HSS according to locally configured policy information. For example, temporary authorization withdrawing may not be notified to the HSS, or the authorization update type and the time information are carried in the message for notifying the HSS in Step 407. The message may further carry the authorization type, for example, one of a full authorization, a conditional authorization and no authorization.

If the message does not carry the IMSI, the HSS is required to judge the UE which may be affected according to the ID of the PLMN requiring reauthorization, and update its subscription data.

In Steps 409˜410, for the affected UE, the HSS may judge to reinsert user data into an MME where the UE is registered according to a registration state of the UE. The MME judges a policy change type, and if a broadcast policy of the UE changes and an 51 bearer is created for the UE, the MME is required to notify that authorization information of the ProSe changes through a user context modification message.

If the authorization update type and the time information are carried in Step 407, the authorization update type and the time information may also be included in the subscription data inserted by the HSS.

### Embodiment 3

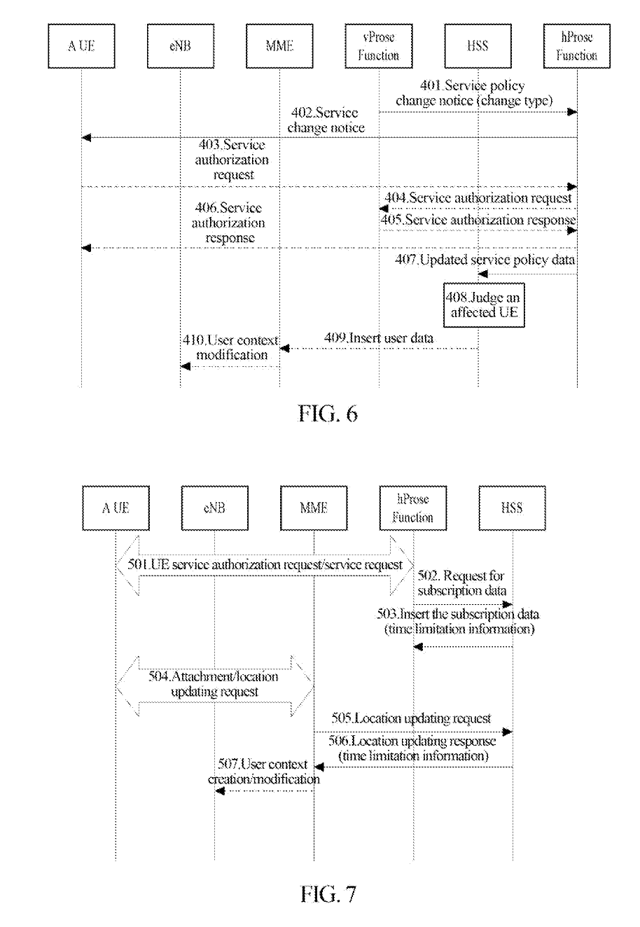

An example of addition of time limitation information of an authorization into subscription data of a ProSe, as shown in FIG. 7, includes the following steps.

In Step 501, a ProSe server of a home network may be triggered to acquire subscription data from an HSS in a process of requesting for a service authorization or requesting for a service (broadcast and monitoring) and the like by UE.

In Steps 502˜503, the acquired subscription data may include time limitation information of an authorization for some service (i.e. communication and/or discovery) corresponding to a PLMN, and the time may be absolute time, and may also be relative time.

When finding that an authorization time limitation of certain UE is exceeded, the ProSe server of the home network may notify the related UE.

In Step 504, a MME may be triggered to acquire the subscription data from the HSS in an attachment or location updating process by the UE.

In Steps 505˜506, the MME initiates a location updating request to the HSS to acquire the subscription data, and the HSS returns a location updating response carrying the subscription data of a user, which may include the time limitation information of the authorization for some service (such as communication and/or discovery), herein the time may be absolute time, and may also be relative time.

If an authorization time limitation of a broadcast policy of the UE is exceeded, for example, permission is changed into forbidding after a certain time and an S1 bearer is created for the UE, the MME may notify that authorization information of the ProSe changes through a user context modification message, and withdraw a response resource.

With addition of the time limitation information into the subscription data, when the time limitation information changes, the HSS is required to notify the ProSe server of the home network and the MME through the updated subscription data. If the authorization is timed out and the S1 bearer is created for the UE, the MME is required to notify that the authorization information of the ProSe changes through the user context modification message.

If being implemented in form of software function module and sold or used as an independent product, the integrated module in the embodiment of the present document may also be stored in a computer-readable storage medium. Based on such an understanding, the technical solution of the embodiment of the present document substantially or a part with contributions to the conventional art may be embodied in form of software product, and the computer software product is stored in a storage medium, including a plurality of instructions arranged to enable a computer (which may be a personal computer, a server, network device or the like) to execute all or part of the method in each embodiment of the present document. The preceding storage medium includes: various media capable of storing program codes such as a U disk, a mobile hard disk, a Read-Only Memory (ROM), a Random Access Memory (RAM), a magnetic disk or a compact disc. Therefore, the embodiment of the present document is not limited to any specific hardware and software combination.

Correspondingly, the embodiment of the present document further provides a computer storage medium, in which a computer program is stored, the computer program is arranged to execute a method for processing an authorization change of a ProSe in the embodiment of the present document.

The above is only the preferred embodiment of the present document and not intended to limit the scope of protection of the present document.

### INDUSTRAIL APPLICABILITY

According to the method for processing the authorization change of the ProSe in the embodiment of the present document, the method includes that: the ProSe server of the visited network or the local network triggers reauthorization of the ProSe; and the ProSe server of the visited network or the local network sends the updated authorization information to the ProSe server of the home network, the updated authorization information includes the update time limitation indication, and/or the time information, and/or the authorization type. By the embodiment of the present document, processing is implemented without the HSS, so that the problem that a load of a network element such as the HSS is increased by impact of the authorization change of the ProSe on the network element such as the HSS is solved.

1. A method for processing an authorization change of a Proximity-based Service ProSe, comprising:
triggering, by a ProSe server of a visited network or a local network, reauthorization of the ProSe; and
sending, by the ProSe server of the visited network or the local network, updated authorization information to a ProSe server of a home network, wherein the updated authorization information comprises: an update time limitation indication, and/or time information, and/or an authorization type.

2. The method according to claim 1, wherein the update time limitation indication is arranged to indicate that an authorization update type of the home network is a temporary update or a permanent update,
and,
wherein the method further comprises: setting the time information to be time information for temporary forbidding if the authorization update type is a temporary update, wherein the time information comprises: absolute time or relative time.

3. The method according to claim 1, wherein after the ProSe server of the home network receives the updated authorization information, the method further comprises:
notifying, by the ProSe server of the home network, User Equipment UE of the updated authorization information; or,
sending, by the ProSe server of the home network, an updated authorization notice to the UE to trigger the UE to initiate a service authorization request; or,
notifying, by the ProSe server of the home network, the UE of the updated authorization information after the UE initiates the service authorization request.

4. The method according to claim 1, wherein the method further comprises:
receiving, by the ProSe server of the visited network or the local network, the service authorization request initiated by the UE, and forwarding the service authorization request to the ProSe server of the home network;
receiving, by the ProSe server of the visited network or the local network, a service authorization response for the service authorization request from the ProSe server of the home network, and acquiring the updated authorization information carried in the service authorization response; and
notifying, by the ProSe server of the visited network or the local network, the UE of the updated authorization information.

5. The method according to claim 1, wherein the method further comprises:
receiving, by the ProSe server of the home network, the service authorization request initiated by the UE, and notifying the UE of the updated authorization information
and,
wherein the method further comprises:
receiving, by the ProSe server of the home network, the service authorization request initiated by the UE, and sending the service authorization request to the ProSe server of the visited network or the local network; and
receiving, by the ProSe server of the visited network or the local network, the service authorization request sent by the ProSe server of the home network, and returning a service authorization response for the service authorization request to the ProSe server of the home network, wherein the updated authorization information is carried in the service authorization response.

6-7. (canceled)

8. The method according to claim 1, wherein an implementation manner for the update time limitation indication comprises any one of manners as follows:
the update time limitation indication is implemented in a manner of adding a new Information Element IE; and
the update time limitation indication is implemented in an implicit manner,
and,
wherein implementation of the update time limitation indication in the implicit manner comprises that:
if the time information is not carried, it is indicated that the update time limitation indication is arranged to indicate that the authorization update type of the home network is a permanent update; and
if the time information is carried, it is indicated that the update time limitation indication is arranged to indicate that the authorization update type of the home network is a temporary update and identify that the update is valid within a time period represented by the time information.

9. (canceled)

10. The method according to claim 1, wherein the authorization type comprises, but is not limited to: any one type of a full authorization, a conditional authorization and no authorization.

11-21. (canceled)

22. The method according to claim 1, further comprising:
obtaining, by a ProSe server of a home network or a Mobility Management Element MME of a visited network, authorization information from a Home Subscriber Server HSS, wherein the authorization information comprises: an update time limitation indication, and/or time information, and/or an authorization type.

23. (canceled)

24. A first network element device, comprising:
a triggering unit, arranged for a Proximity-based Service ProSe server of a visited network or a local network to trigger reauthorization of a ProSe; and
a sending unit, arranged for the ProSe server of the visited network or the local network to send updated authorization information to a ProSe server of a home network, wherein the updated authorization information comprises: an update time limitation indication, and/or time information, and/or an authorization type.

25. The first network element device according to claim 24, wherein the update time limitation indication is arranged to indicate that an authorization update type of the home network is a temporary update or a permanent update,
and,
wherein the time information is set to be time information for temporary forbidding if the authorization update type is a temporary update; and
the time information comprises: absolute time or relative time.

26. The first network element device according to claim 24, wherein the first network element device further comprises:
an update notification unit, arranged for the ProSe server of the home network to notify User Equipment UE of the updated authorization information; or, for the ProSe server of the home network to send an updated authorization notice to the UE to trigger the UE to initiate a service authorization request; or, for the ProSe server of the home network to notify the UE of the updated authorization information after the UE initiates the service authorization request.

27. The first network element device according to claim 24, wherein the sending unit is further arranged for the ProSe server of the visited network or the local network to receive the service authorization request initiated by the UE, and forward the service authorization request to the ProSe server of the home network; for the ProSe server of the visited network or the local network to receive a service authorization response for the service authorization request from the ProSe server of the home network, and acquire the updated authorization information carried in the service authorization response; and for the ProSe server of the visited network or the local network to notify the UE of the updated authorization information.

28. The first network element device according to claim 24, wherein the first network element device further comprises:
a notification unit, arranged for the ProSe server of the home network to receive the service authorization request initiated by the UE, and notify the UE of the updated authorization information,
and,
wherein the sending unit is further arranged to send the service authorization request to the ProSe server of the visited network or the local network; and
a receiving unit is arranged for the ProSe server of the visited network or the local network to receive the service authorization request sent by the ProSe server of the home network, and return a service authorization response for the service authorization request to the ProSe server of the home network, wherein the updated authorization information is carried in the service authorization response.

29-30. (canceled)

31. The first network element device according to claim 24, wherein an implementation manner for the update time limitation indication comprises any one of manners as follows:
the update time limitation indication is implemented in a manner of adding a new Information Element IE; and
the update time limitation indication is implemented in an implicit manner,
and,
wherein implementation of the update time limitation indication in the implicit manner comprises that:
if the time information is not carried, it is indicated that the update time limitation indication is arranged to indicate that the authorization update type of the home network is a permanent update; and
if the time information is carried, it is indicated that the update time limitation indication is arranged to indicate that the authorization update type of the home network is a temporary update and identify that the update is valid within a time period represented by the time information.

32. The first network element device according to claim 24, wherein the authorization type comprises: any one type of a full authorization, a conditional authorization and no authorization.

33. The first network element device according to claim 24, further comprising an acquisition unit, arranged for a Proximity-based Service ProSe server of a home network or a Mobility Management Element MME of a visited network to obtain authorization information from a Home Subscriber Server HSS, wherein the authorization information comprises: an update time limitation indication, and/or time information, and/or an authorization type.

34. A second network element device, comprising:
a receiving unit, arranged for a Proximity-based Service ProSe server of a home network to receive updated authorization information sent by a ProSe server of a visited network or a local network, wherein the updated authorization information comprises: an update time limitation indication, and/or time information, and/or an authorization type.

35. The second network element device according to claim 34, wherein the update time limitation indication is arranged to indicate that an authorization update type of the home network is a temporary update or a permanent update,
and,
wherein the time information is time information for temporary forbidding if the authorization update type is a temporary update; and
the time information comprises: absolute time or relative time.

36. The second network element device according to claim 34, wherein a notification unit is arranged for the ProSe server of the home network to notify User Equipment UE of the updated authorization information; or, for the ProSe server of the home network to send an updated authorization notice to the UE to trigger the UE to initiate a service authorization request; or, for the ProSe server of the home network to notify the UE of the updated authorization information after the UE initiates the service authorization request.

37. The second network element device according to claim 34, wherein the receiving unit is further arranged for the ProSe server of the home network to receive a service authorization request sent by the ProSe server of the visited network or the local network, and return a service authorization response for the service authorization request to the ProSe server of the visited network or the local network, wherein the updated authorization information is carried in the service authorization response.

38. The second network element device according to claim 34, wherein the receiving unit is further arranged for the ProSe server of the home network to receive the service authorization request initiated by the UE, and notify the UE of the updated authorization information,
and,
wherein the receiving unit is further arranged for the ProSe server of the home network to, after forwarding the service authorization request to the ProSe server of the visited network or the local network, receive a service authorization response for the service authorization request returned by the ProSe server of the visited network or the local network, wherein the updated authorization information is carried in the service authorization response,
and,
wherein the second network element device further comprises:
a judgment unit, arranged for the ProSe server of the home network to judge whether it is necessary to notify a Home Subscriber Server HSS according to locally configured policy information.

39-41. (canceled)

42. The second network element device according to claim 34, wherein an implementation manner for the update time limitation indication comprises any one of manners as follows:
the update time limitation indication is implemented in a manner of adding a new Information Element IE; and
the update time limitation indication is implemented in an implicit manner,
and,
wherein implementation of the update time limitation indication in the implicit manner comprises that:
if the time information is not carried, it is indicated that the update time limitation indication is arranged to indicate that the authorization update type of the home network is a permanent update; and
if the time information is carried, it is indicated that the update time limitation indication is arranged to indicate that the authorization update type of the home network is a temporary update and identify that the update is valid within a time period represented by the time information.

43. (canceled)

44. The second network element device according to claim 34, wherein the authorization type comprises: any one type of a full authorization, a conditional authorization and no authorization.

45. A method for processing an authorization change of a Proximity-based Service ProSe, comprising:
triggering a ProSe server of a home network to request a Home Subscriber Server HSS for acquiring subscription data when User Equipment UE initiates a service authorization request or a service request; and
acquiring, by the ProSe server of the home network, the subscription data, wherein the subscription data comprises time limitation information of an authorization.

46. The method according to claim 45, wherein the method further comprises:
Triggering, by the UE, a Mobility Management Element MME to acquire the subscription data from the HSS in an attachment or location updating process,
wherein the subscription data returned by the HSS comprises the time limitation information of the authorization,
and
wherein the time limitation information of the authorization comprises absolute time or relative time.

47. (canceled)

48. The method according to claim 45, wherein, when the time limitation information of the authorization in the subscription data changes, the HSS notifies the ProSe server of the home network or the MME of updated subscription data,
and,
wherein the method further comprises: when the time limitation information of the authorization is timed out, the ProSe server of the home network notifies the UE that the authorization has expired; or,
when the time limitation information of the authorization changes, the ProSe server of the home network notifies the UE of updated authorization information, or triggers the UE to initiate a service authorization request, or notifies the UE of the updated authorization information after the UE initiates the service authorization request,
and,
wherein the method further comprises: when the time limitation information of the authorization is timed out, notifying, by the MME, that authorization information of a wireless network element terminal changes.

49-50. (canceled)

51. A third network element device, comprising:
a triggering unit, arranged to trigger a Proximity-based Service ProSe server of a home network to request a Home Subscriber Server HSS for acquiring subscription data when User Equipment UE initiates a service authorization request or a service request; and
an acquisition unit, arranged for the ProSe server of the home network to acquire the subscription data, wherein the subscription data comprises time limitation information of an authorization.

52. The network element device according to claim 51, wherein the triggering unit is further arranged for the UE to trigger a Mobility Management Element MME to acquire the subscription data from the HSS in an attachment or location updating process; and
the acquisition unit is further arranged to include the time limitation information of the authorization in the subscription data returned by the HSS,
and,
wherein the time limitation information of the authorization comprises absolute time or relative time.

53. (canceled)

54. The network element device according to claim 51, wherein the network element device further comprises:
a first notification unit, arranged for the HSS to, when the time limitation information of the authorization in the subscription data changes, notify the ProSe server of the home network or the MME of updated subscription data,
and,
wherein the network element device further comprises:
a second notification unit, arranged for the ProSe server of the home network to, when the time limitation information of the authorization is timed out, notify the UE that the authorization has expired; or,
for the ProSe server of the home network to, when the time limitation information of the authorization changes, notify the UE of updated authorization information, or trigger the UE to initiate a service authorization request, or notify the UE of the updated authorization information after the UE initiates the service authorization request,
and,
wherein the network element device further comprises:
a third notification unit, arranged for the MME to, when the time limitation information of the authorization is timed out, notify that authorization information of a wireless network element terminal changes.

55-56. (canceled)
